(19) United States
(12) Patent Application Publication
(10) Pub. No.: US 2005/0257038 A1
(43) Pub. Date: Nov. 17, 2005

(54) Automotive electronic control unit and a method for storing configuration data in the same

(76) Inventors: Jason Miller, Woodhaven, MI (US); Gwendolyn Ald, Dearborn, MI (US); Steven DiLodovico, Allen Park, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/844,098

(22) Filed: May 11, 2004

(51) Int. Cl. G06F 9/00

(52) U.S. Cl. 713/1

(57) ABSTRACT

The invention discloses a method of storing configuration information in an Electronic Control Unit (ECU). This method discloses storing configuration information at a sequence of address locations. After all of the configuration information is stored, a recognizable block separator is stored in the next address location in the sequence. This block separator segregates the configuration information from the remaining information stored in the ECU. The configuration information can be retrieved by reading the data in the sequence of address locations. When the recognizable block separator is retrieved, the retrieval of the configuration information is complete. The information retrieved (not including the block separator) is all of the configuration information for the ECU. This method greatly simplifies the retrieval of configuration information from an ECU and the replacement of a faulty or inoperable ECU with an operable ECU that has been properly configured.

### TECHNICAL FIELD OF THE INVENTION

The method described herein relates in general to the storage and retrieval of configuration data in an electronic control unit (“ECU”) and, in particular, to a specific method of storing configuration data in an ECU such that this information can be easily retrieved from the ECU.

### BACKGROUND OF THE INVENTION

The use of ECU's is well-known in the art. An ECU is often a small microprocessor or microcontroller configured to perform a specific function or set of functions in a larger system, for example an automobile. ECU's are used in automobiles for various different applications, e.g., to control the operation of each of the powertrain, anti-lock braking, restraint, lighting, audio, and telematics systems.

An ECU in a system has to be properly configured in order for it to perform its specific function. This is usually accomplished by writing configuration information to the ECU. Configuration information is data that the ECU uses to control the larger system. For example, an ECU that controls the powertrain of an automobile must be configured to properly shift the transmission. The configuration information comprises data that indicates when such a transmission shift should take place, for example the number of revolutions per minute (RPM), speed, accelerator position, etc. This data is referenced by the ECU during operation, so that when the proper conditions exist, the ECU then shifts the transmission. Automobile manufacturers can reconfigure the ECU, i.e., change the configuration data, in order to tune the performance of the vehicle, for example to achieve better gas mileage.

In the past, a programmer would input configuration information into the ECU and record, in a separate database for example, where the information is stored and what the information comprised for the particular ECU. In order to retrieve the configuration information from the ECU, one had to consult the database that described the locations in which it is stored and then retrieve the information from these locations.

The process described above requires that a database be maintained and be made accessible to all service workers who may need to configure or reconfigure an ECU. For example, an automobile manufacturer would be required to maintain, publish, and update a reference guide that each and every service worker could review in order to provide service on an ECU system. An excess of time, effort, and expense must be expended by manufacturers to accomplish this and by service workers in order to determine the configuration information of a specific ECU. A method that allows for the easy determination and retrieval of the configuration information of an ECU would be desirable.

### SUMMARY OF THE INVENTION

This invention relates to a method for the storing of configuration information in an ECU so that it can be easily retrieved from the ECU itself. Furthermore, this invention eliminates the need for maintaining a database that stores the size and location of the configuration information.

In one aspect, the invention is directed to a method for storing configuration data of an Electronic Control Unit (ECU). The method includes the step of choosing a sequence of address locations of the ECU at which to store the configuration data. The sequence of address locations includes a beginning address location. The method further includes the step of storing the configuration data at the address locations in the chosen sequence starting at the beginning address location. The method also comprises storing a block separator at an ultimate address location, which is the next address location in the sequence after the last address location in which at least a portion of the configuration data is stored. This method allows the configuration data to be determined from the ECU by retrieving data stored at the address locations in the sequence, starting at the beginning address location and continuing until the block separator is retrieved.

In another aspect, the invention is directed to a method of retrieving configuration data of an ECU. This method comprises retrieving data stored at a sequence of address locations, starting at a beginning address location and continuing in the sequence until a block separator is retrieved; the configuration data comprising the data retrieved.

In another aspect, the invention is directed to a method of replacing a faulty or inoperable ECU with an operational ECU. The method includes the step of retrieving configuration data from the faulty ECU. This step comprises retrieving data stored at a sequence of address locations, starting at a beginning address location and continuing until a block separator is retrieved; the configuration data comprising the data retrieved in the step. The method further includes the step of storing the configuration data in the operational ECU, wherein this step comprises writing the configuration data at the sequence of address locations in the operational ECU and storing the block separator at an ultimate address location, which is the next address location in the sequence after the last address location in which at least a portion of the configuration data is stored. The method further comprises replacing the faulty ECU with the operational ECU in said system.

In another aspect, the invention is directed to an ECU that contains configuration data stored at its memory address locations according to the method described above. The ECU comprises a plurality of memory address locations, configuration data, a block separator, and a software program. The configuration data is stored at the memory address locations in a chosen sequence starting at a beginning address location. A block separator is stored at an ultimate address location, which is the next address location in the sequence after the last address location in which at least a portion of the configuration data is stored.

### BRIEF DESCRIPTION OF THE DRAWINGS

These and other features and advantages of the present invention will be apparent to those of ordinary skill in the art in view of the detailed description of the preferred embodiment which is made with reference to the drawings, a brief description of which is provided below.

FIG. 1 is a flowchart describing storage of configuration information in an ECU according to the present invention.

FIG. 2 is a flowchart describing the retrieval of configuration information of an ECU according to the present invention.

FIG. 3 is a simplified illustration of an ECU's memory address locations that is configured according to the present invention.

### DETAILED DESCRIPTION OF THE PREFERRED EMBODIMENTS

This invention is a method of storing configuration information in an ECU such that it can be easily retrieved. This method includes the step of choosing a sequence of address locations in which to store the configuration information, e.g., consecutive address locations moving higher, consecutive address locations moving lower, every other address location, every fifth address location, etc. A beginning address location is also chosen, so that the sequence has a standard starting point. The preferred starting point is the first address location of the ECU, for example address location 00, and the preferred sequence is consecutive address locations moving higher, i.e., 00, 01, 02, 03, and so on.

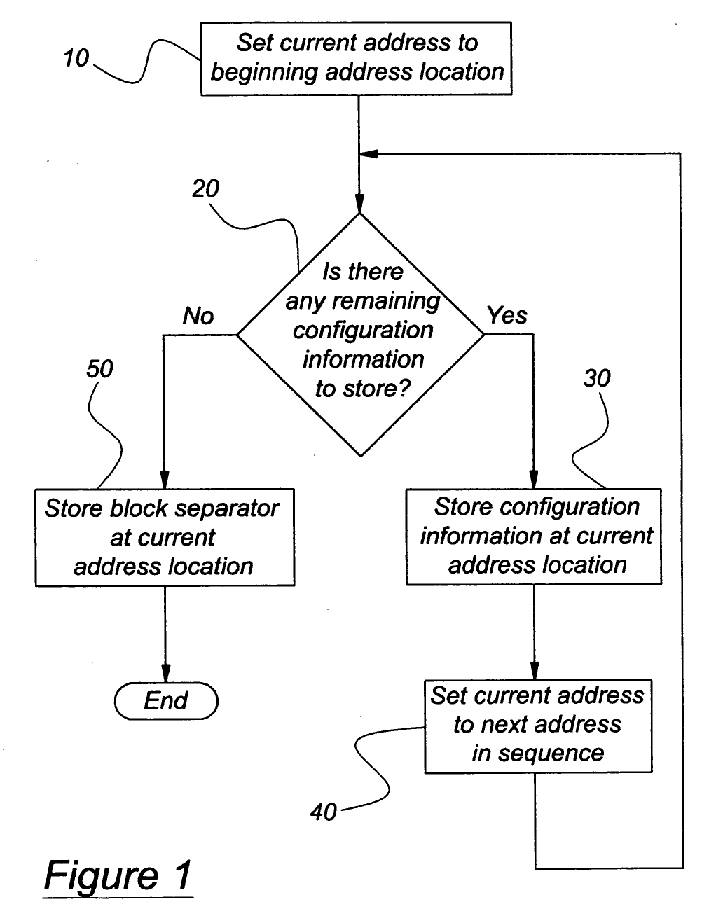

FIG. 1 is a flowchart describing a preferred embodiment of the present invention. At step 10, the current address is set to the beginning address location of the sequence. At step 20, the method queries whether there exists any remaining configuration information left to store. If more configuration information remains, at least a subset of the remaining configuration information for the ECU is stored at the current address location, shown in step 30. At step 40, the current address location is then incremented to the next address location in the sequence, and the process returns to step 20. This process iterates until all of the configuration information is stored in sequence, at which point step 20 indicates that there is no remaining configuration information to store. At this point in the process (step 50) the block separator is stored at the current address location, which by means of the process is the next address location in the sequence after that which is filled with configuration information. That is, every address in the sequence before the location of the block separator contains at least a subset of the configuration information, and every address in the sequence after the location of the block separator contains no configuration information. The block separator may be any data that does not appear in the configuration information or, in a preferred embodiment, the block separator comprises no data. The block separator must be easily recognizable, i.e., distinct from the configuration information.

The size of the configuration information, i.e., the number of address locations that the configuration information requires, is irrelevant; the configuration information can take as many or as few address locations as necessary, even only one. The remaining address locations, those that do not contain either configuration information or the block separator, can be used to store other information relating to the operation of the ECU, for example software source code. This other information is preferably stored after the configuration information is stored, so that there is no size limit on the amount of configuration information that can be stored.

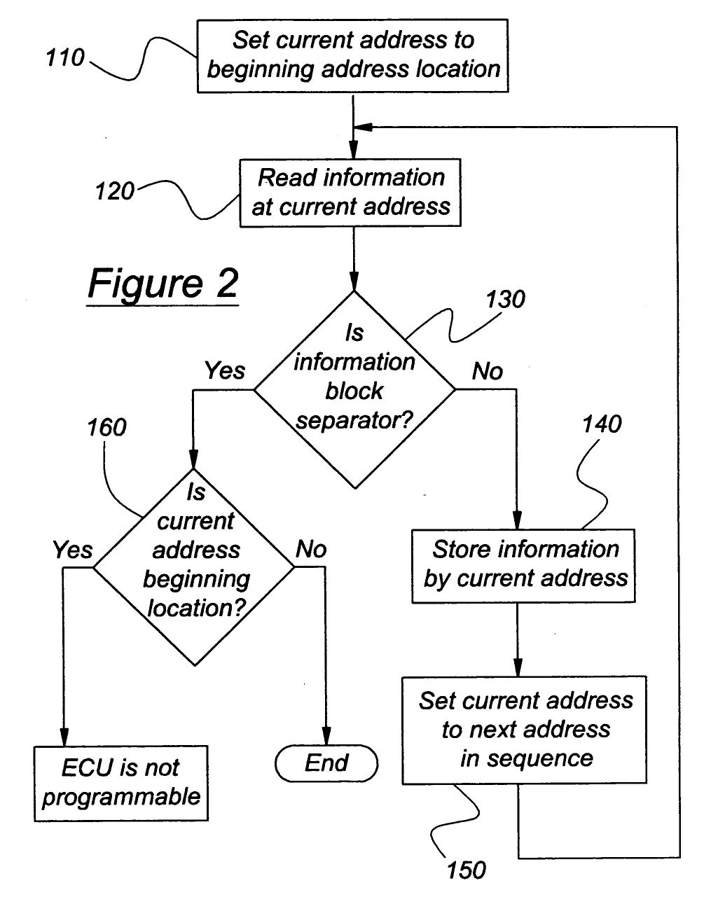

In another aspect, this invention is related to a method of retrieving configuration data, which is stored by the method described above, from an ECU. FIG. 2 is a flowchart detailing the steps in this process. In block 110, the process begins by setting the current address location to the beginning address location of the sequence. At step 120, the data at the current address location is retrieved. At step 130, the retrieved data is evaluated. If the retrieved data is not the block separator, the retrieved data is stored according to its address location at step 140. The current address location is then incremented to point to the next address location in the sequence at step 150, and the process returns to step 120. If the retrieved data is the block separator, the current address is evaluated at step 160. If the block separator is in the beginning address location, i.e., if the current address is the beginning address location, then the ECU has no configuration information (it is not programmable) and the process is complete. If the current address is not the beginning address location, the process is complete, and all previously stored data is the configuration information for the ECU.

In yet another aspect, the invention is related to a method for replacing a faulty ECU with an operational ECU. An ECU is faulty if it does not operate in the manner in which it is intended. In the past, replacing a faulty programmable ECU was a difficult and time-consuming task. The replacement ECU had to be configured by storing the correct configuration information at the correct address locations. In order to accomplish this, one had to consult a database or manual to learn the address location(s) and the size of the configuration information so that it could be retrieved from the faulty ECU and stored in the replacement ECU in the same location. This invention standardizes the retrieval and storage of the configuration information in order to simplify this process.

Essentially, the configuration information is retrieved from the faulty ECU according to the method described above in reference to FIG. 2. This configuration information is then stored in the operational ECU in the same address locations from which it was retrieved. Storing the configuration information in the replacement ECU can be accomplished, for example, by following the storing method described above in regard to FIG. 1. However, it is also possible to write the configuration information to the replacement ECU by doing a Direct Memory Access (DMA) or similar read/write process from the faulty to operational ECU. A DMA process is a high-speed transfer of data without involving the microprocessor. Furthermore, it should be apparent that the retrieval of the configuration information from the faulty ECU can take place simultaneously with the storing of the configuration information in the replacement ECU and still be within the scope of this invention. This invention greatly reduces the time required to configure the replacement ECU because only the configuration information needs to be copied and stored. In the past, the entire contents of the faulty ECU's memory would be transferred to the replacement ECU in order to insure that the configuration information was properly stored. This invention eliminates the need for wholesale copying of memory contents or referring to service manuals in order to properly configure (or reconfigure) an ECU.

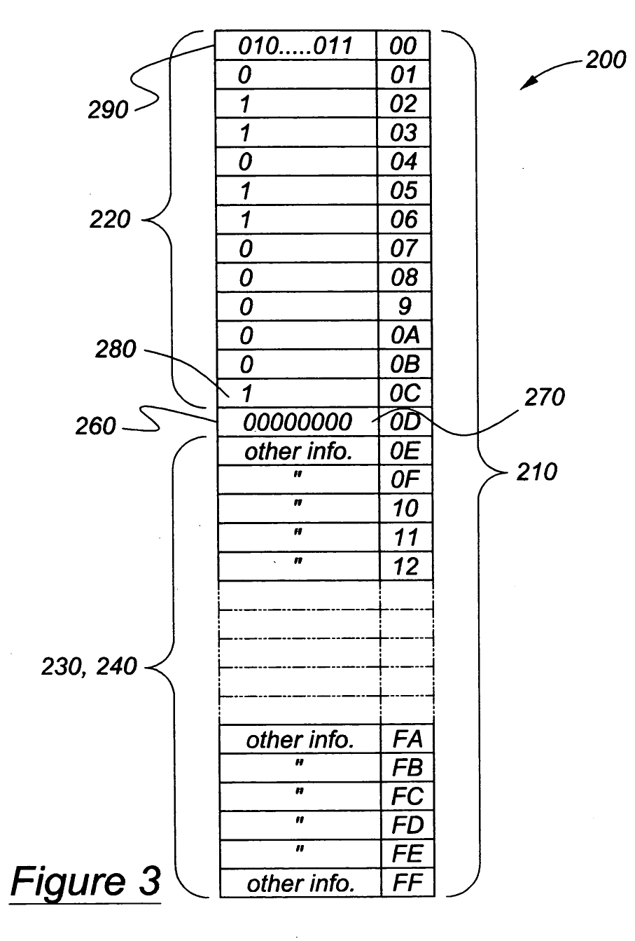

In another aspect, the invention is related to an ECU that contains configuration information stored at its memory address locations according to the method described above, as shown in FIG. 3. The plurality of memory address locations 210 of the ECU 200 may contain configuration information 220 of the ECU 200, a software program 230, and other information 240. A sequence of memory address locations is chosen at which to store the configuration information 220. The sequence includes a beginning memory address location 250. In FIG. 3 a preferred embodiment is shown; the sequence is a consecutive order, starting at memory address location 00 (the beginning memory address location 250) and continuing higher (i.e., 01, 02, 03, etc.). The configuration information 220 is stored at the memory address locations 210, starting at the beginning memory address location 250 and continuing in the sequence of memory address locations 210. The amount of configuration information 220 to be stored is irrelevant; the configuration information 220 is stored in as many memory address locations 210 in the sequence as necessary to contain all of the configuration information 220. A block separator 260, like the one described above, is stored at the ultimate memory address location 270, which is the next memory address location 210 in the sequence after the final memory address location 280 that contains a subset of the configuration information 220. In FIG. 3, the final memory address location 280 is memory address location 0C, and the ultimate memory address location 270 is the next memory address location 210 in the sequence, i.e., memory address location 0D. The remaining memory address locations 210, those that do not contain either configuration information 220 or the block separator 260, may contain a software program 230 or other information 240, e.g., chip identification information, error checking data, and other data necessary for the ECU to operate.

Persons of ordinary skill in the art will readily appreciate that a method for storing and retrieving configuration data in an electronic control unit has been provided. Manufacturers implementing this method of storing configuration information, and maintenance personnel servicing ECU's configured according to this method, will benefit from the decreased cost, effort, and time associated with configuring and reconfiguring ECU's with the method provided.

The foregoing description has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended hereto.

1. A method for storing a plurality of configuration data of an Electronic Control Unit (ECU) comprising:
choosing a sequence of address locations of said ECU at which to store said plurality of configuration data, said sequence of address locations comprising a beginning address location,
storing said plurality of configuration data at said address locations in said sequence starting at said beginning address location, and
storing a block separator at an ultimate address location, said ultimate address location comprising the next address location in said sequence of address locations after a final address location, said final address location comprising the last address location in said sequence in which at least a portion of said plurality of configuration data is stored, whereby said plurality of configuration data can be determined from said ECU by retrieving data stored at said address locations in said sequence, starting at said beginning address location and continuing until said block separator is retrieved.

2. The method of claim 1, wherein said beginning address location comprises the first address location of said ECU.

3. The method of claim 2, wherein said sequence comprises a consecutive order.

4. The method of claim 1, wherein said sequence comprises a consecutive order.

5. The method of claim 1, wherein said block separator comprises no data.

6. A method for retrieving a plurality of configuration data of an Electronic Control Unit (ECU) comprising retrieving data stored at a sequence of address locations, starting at a beginning address location and continuing in said sequence until a block separator is retrieved, wherein said plurality of configuration data comprises said data retrieved.

7. The method of claim 6, wherein said beginning address location comprises the first address location of said ECU.

8. The method of claim 7, wherein said sequence comprises a consecutive order.

9. The method of claim 6, wherein said sequence comprises a consecutive order.

10. The method of claim 6, wherein said block separator comprises no data.

11. The method of claim 6, wherein said block separator comprises recognizable data, said recognizable data being distinct from said plurality of configuration data.

12. A method for replacing a faulty electronic control unit (ECU) in a system with an operational ECU comprising:
retrieving a plurality of configuration data from said faulty ECU, wherein said retrieving comprises retrieving data stored at a sequence of address locations, starting at a beginning address location and continuing in said sequence until a block separator is retrieved, said plurality of configuration data comprising said data retrieved;
storing said plurality of configuration data in said operational ECU, wherein said storing comprises writing said plurality of configuration data at said sequence of address locations in said operational ECU and storing said block separator at an ultimate address location, said ultimate address location comprising the next address location in said sequence of address locations after a final address location, said final address location comprising the last address location in said sequence in which at least a portion of said plurality of configuration data is stored; and
replacing said faulty ECU with said operational ECU in said system.

13. The method of claim 12, wherein said beginning address location comprises the first address location of said ECU.

14. The method of claim 13, wherein said sequence comprises a consecutive order.

15. The method of claim 12, wherein said sequence comprises a consecutive order.

16. The method of claim 12, wherein said block separator comprises no data.

17. The method of claim 12, wherein said retrieving and said storing occur substantially simultaneously.

18. An Electronic Control Unit (ECU) comprising:
a plurality of memory address locations;
a plurality of configuration data stored at a first subset of said plurality of memory address locations;
said first subset of said plurality of memory address locations comprising a sequence of memory address locations,
a software program stored at a second subset of said plurality of memory address locations; and
a block separator, said block separator being stored at an ultimate memory address location, said ultimate memory address location comprising the next memory address location in said sequence after the last memory address location in said sequence at which at least a subset of said plurality of configuration data is stored.

19. The system of claim 18, wherein said first subset of memory address locations comprises at least the first memory address location of said ECU.

20. The system of claim 19, wherein said sequence comprises a consecutive order.

21. The system of claim 18, wherein said sequence comprises a consecutive order.

22. The system of claim 18, wherein said block separator comprises no data.

23. The system of claim 18, wherein said sequence comprises at least a beginning address location, whereby said plurality of configuration data can be determined from said ECU by retrieving data stored at said plurality of memory address locations, starting at said beginning address location and continuing in said sequence until said block separator is retrieved.

24. The system of claim 18, wherein said block separator comprises recognizable data, said recognizable data being distinct from said plurality of configuration data.

25. The system of claim 24, wherein said sequence comprises at least a beginning address location, whereby said plurality of configuration data can be determined from said ECU by retrieving data stored at said plurality of memory address locations, starting at said beginning address location and continuing in said sequence until said block separator is retrieved.
